(19) United States
(12) Patent Application Publication
(10) Pub. No.: US 2009/0057335 A1
(43) Pub. Date: Mar. 5, 2009

(54) Magnetizing dispenser for wine, spirit or beverage container

(75) Inventors: Kam Sung Tang, Hong Kong (CN); Chao Yang Robert Lo, Hong Kong (CN)

Correspondence Address: BYIP, LTD., P.O. BOX 1484, GENERAL POST OFFICE, HONG KONG, CN

(73) Assignee: MAGICFLAVOR INVESTMENT INC., Linz (AT)

(21) Appl. No.: 11/665,787

(22) PCT Filed: Nov. 1, 2005
(86) PCT No.: PCT/CN2005/001820

§ 371 Date: Apr. 19, 2007

Related U.S. Application Data
(60) Provisional application No. 60/623,225, filed on Nov. 1, 2004.

(51) Int. Cl. B67B 7/00

(52) U.S. Cl. 222/1

(57) ABSTRACT

A magnetizing fluid dispenser that allows the beverage to flow through a magnetic field in order to change the tastes or textures of the wine, spirit, and other beverages is provided. The magnetizing dispenser includes a spout and a magnet. The spout is sized and shaped to allow fluid inside the container to be poured out through a predefined path in the spout. The magnet is capable of generating a magnetic field. When the fluid is poured out, it passes through the magnetic field. The relative position of the spout and the magnet is adjustable.

### CROSS REFERENCE TO RELATED APPLICATION

This application claims priority from U.S. Provisional Application Ser. No. 60/623,225, filed Nov. 1, 2004, which is herein incorporated by reference.

### FIELD OF THE INVENTION

The present invention relates to a magnetizing device. In particular, the present invention relates to a magnetizing dispenser for wine, spirit or beverage containers, such as bottles, pots, etc.

### BACKGROUND OF THE INVENTION

It is known that many alcoholic beverages are aged in wood barrels or have wood or wood chips added to the product for a time to allow the characteristics of the wood to enhance the organoleptic properties of the beverage including flavor and odor.

Tannins are the harsh, bitter, astringent, dry tasting substances, imparted by grape skins, seeds, stems and or the use of wood barrels, strips or chips, which allow wines to age and or impart a variety of different taste characteristics to wines and other alcoholic beverages. In wine these tannins will dissipate over the years and thus in general an older wine will have a softer, smoother and fruitier taste than it did as a young wine. In spirits, tannins are generally derived from a variety of new and used wood barrels, in which the spirits are allowed to aged for a period of time, in order to impart the finished product with a variety of taste finishes.

When these alcoholic products are released to the public they generally have not been given enough time to age and reach their full maturity and flavor, through the use of climate controlled wine and spirits cellars, before they are released to the public. The additional expense to the manufacturer of cellaring a product for additional years, until it reached its optimum maturity, would add considerable cost to the finished product. The general public generally consumes these products before they are at their best.

The use of magnets minimizes the effect of acids and tannins. Exposing alcoholic beverages to a magnetic field of a particular orientation at the time of serving the beverages is therefore desired.

In coffee, tea and some fruit juices, such exposure to a magnetic field can reduce the perceived taste of acidity.

### SUMMARY OF THE INVENTION

A magnetizing fluid dispenser that allows the beverage to flow through a magnetic field in order to change the tastes or textures of the wine, spirit, and other beverages is provided. In one aspect, the magnetizing dispenser includes a spout and a magnet. The spout is sized and shaped to allow fluid inside the container to be poured out through a predefined path in the spout. The magnet is capable of generating a magnetic field. When the fluid is poured out, it passes through the magnetic field. The relative position of the, spout and the magnet is adjustable. When pouring the fluid out of the container, the magnetic field can cut through an interface between the fluid being poured out and air at an adjustable angle. The dispenser can therefore change the original flavor of the beverage to different flavors.

In one embodiment, the magnet and the spout are rotatable with respect to each other. The magnet can have a donut shape with a cavity. When the fluid is poured out, the fluid passes through the cavity of the magnet.

A base mount can be included in the magnetizing dispenser. The magnet can be fixedly embedded in the base mount. The relative position of the base mount and the spout is therefore adjustable. The base mount can have an end adapted to engage with the mouth of the container. The base mount can include a dial surface with a plurality of indicia provided thereon and the spout can be provided with a pointer pointing at one of said plurality of indicia. The dial surface on the base mount can be a clock style.

### BRIEF DESCRIPTION OF THE DRAWINGS

FIG. 1 is a view of an embodiment of a bottle and a magnetizing dispenser with an adjustable spout.

FIG. 2a is an exploded view of the magnetizing dispenser of FIG. 1.

FIG. 2b is a perspective view a magnet in the magnetizing dispenser of FIG. 2a.

FIG. 3a is a view of the magnetizing dispenser of FIG. 2a with its pointer pointing at 9 O'clock of its scale and positioning upward when pouring the fluid out of the bottle.

FIG. 3b is a perspective view of the magnet in the magnetizing dispenser of FIG. 3a.

FIG. 3c is a cross-sectional view of the magnetizing dispenser of FIG. 3a showing fluid being poured out.

FIG. 3d is a top view of the magnet of FIG. 3b.

FIG. 3e is a top view of the magnet of FIG. 3b showing a level of the fluid when being poured out.

FIG. 4a is a view of the magnetizing dispenser of FIG. 2a with its pointer pointing between 9 and 12 O'clock of its scale and positioning upward when pouring the fluid out of the bottle.

FIG. 4b is a perspective view of the magnet in the magnetizing dispenser of FIG. 4a.

FIG. 4c is a cross-sectional view of the magnetizing dispenser of FIG. 4a showing fluid being poured out.

FIG. 4d is a top view of the magnet of FIG. 4b.

FIG. 4e is a top view of the magnet of FIG. 4b showing a level of the fluid when being poured out.

FIG. 5a is a view of the magnetizing dispenser of FIG. 2a with its pointer pointing at 12 O'clock of its scale and positioning upward when pouring the fluid out of the bottle.

FIG. 5b is a perspective view of the magnet in the magnetizing dispenser of FIG. 5a.

FIG. 5c is a cross-sectional view of the magnetizing dispenser of FIG. 5a showing fluid being poured out.

FIG. 5d is a top view of the magnet of FIG. 5b.

FIG. 5e is a top view of the magnet of FIG. 5b showing a level of the fluid when being poured out.

FIG. 6a is a view of the magnetizing dispenser of FIG. 2a with its pointer pointing between 12 and 3 O'clock of its scale and positioning upward when pouring the fluid out of the bottle.

FIG. 6b is a perspective view of the magnet in the magnetizing dispenser of FIG. 4a.

FIG. 6c is a cross-sectional view of the magnetizing dispenser of FIG. 5a showing fluid being poured out.

FIG. 6d is a top view of the magnet of FIG. 6b.

FIG. 6e is a top view of the magnet of FIG. 6b showing a level of the fluid when being poured out.

FIG. 7a is a view of the magnetizing dispenser of FIG. 2a with its pointer pointing at 3 O'clock of its scale and positioning upward when pouring the fluid out of the bottle.

FIG. 7b is a perspective view of the magnet in the magnetizing dispenser of FIG. 7a.

FIG. 7c is a cross-sectional view of the magnetizing dispenser of FIG. 7a showing fluid being poured out.

FIG. 7d is a top view of the magnet of FIG. 7b.

FIG. 7e is a top view of the magnet of FIG. 7b showing a level of the fluid when being poured out.

FIG. 8a is a view of the magnetizing dispenser of FIG. 2a with its pointer pointing between 3 and 6 O'clock of its scale and positioning upward when pouring the fluid out of the bottle.

FIG. 8b is a perspective view of the magnet in the magnetizing dispenser of FIG. 8a.

FIG. 8c is a cross-sectional view of the magnetizing dispenser of FIG. 8a showing fluid being poured out.

FIG. 8d is a top view of the magnet of FIG. 8b.

FIG. 8e is a top view of the magnet of FIG. 8b showing a level of the fluid when being poured out.

FIG. 9a is a view of the magnetizing dispenser of FIG. 2a with its pointer pointing at 6 O'clock of its scale and positioning upward when pouring the fluid out of the bottle.

FIG. 9b is a perspective view of the magnet in the magnetizing dispenser of FIG. 9a.

FIG. 9c is a cross-sectional view of the magnetizing dispenser of FIG. 9a showing fluid being poured out.

FIG. 9d is a top view of the magnet of FIG. 9b.

FIG. 9e is a top view of the magnet of FIG. 9b showing a level of the fluid when being poured out.

FIG. 10a is a view of the magnetizing dispenser of FIG. 2a with its pointer pointing between 6 and 9 O'clock of its scale and positioning upward when pouring the fluid out of the bottle.

FIG. 10b is a perspective view of the magnet in the magnetizing dispenser of FIG. 10a.

FIG. 10c is a cross-sectional view of the magnetizing dispenser of FIG. 10a showing fluid being poured out.

FIG. 10d is a top view of the magnet of FIG. 10b.

FIG. 10e is a top view of the magnet of FIG. 10b showing a level of the fluid when being poured out.

FIG. 11a is a view of another embodiment of a magnetizing dispenser with an adjustable spout.

FIG. 11b is a perspective view of the magnets of the magnetizing dispenser of FIG. 11a.

FIG. 12a is a view of the magnetizing dispenser of FIG. 11a with its pointer pointing at 12 O'clock position of its scale.

FIG. 12b is a perspective view of the magnets in the magnetizing dispenser of FIG. 12b.

FIG. 13a is a front/cross-sectional view of a magnetizing dispenser of FIG. 3a.

FIG. 13b is a perspective view of the magnet of the magnetizing dispenser of FIG. 13a.

FIG. 14a is a front/cross-sectional view of a magnetizing dispenser of FIG. 11a.

FIG. 14b is a perspective view of the magnet of the magnetizing dispenser of FIG. 14a.

FIG. 15 is a view of another embodiment of a bottle and a magnetizing dispenser with a fixed spout.

FIG. 16a is a view of the magnetizing dispenser of FIG. 15 with the scale's 9 O'clock positioned upward when pouring the fluid out of the bottle.

FIG. 16b is a perspective view of the magnet in the magnetizing dispenser of FIG. 16a.

FIG. 16c is a cross-sectional view of the magnetizing dispenser of FIG. 16a showing fluid being poured out.

FIG. 16d is a top view of the magnet of FIG. 16b.

FIG. 16e is a top view of the magnet of FIG. 16b showing a level of the fluid when being poured out.

FIG. 17a is a view of the magnetizing dispenser of FIG. 15 with a point of the scale between the 9 and 12 O'clock positioned upward when pouring the fluid out of the bottle.

FIG. 17b is a perspective view of the magnet in the magnetizing dispenser of FIG. 17a.

FIG. 17c is a cross-sectional view of the magnetizing dispenser of FIG. 17a showing fluid being poured out.

FIG. 17d is a top view of the magnet of FIG. 17b.

FIG. 17e is a top view of the magnet of FIG. 17b showing a level of the fluid when being poured out.

FIG. 18a is a view of the magnetizing dispenser of FIG. 15 with the scale's 12 O'clock positioned upward when pouring the fluid out of the bottle.

FIG. 18b is a perspective view of the magnet in the magnetizing dispenser of FIG. 18a.

FIG. 18c is a cross-sectional view of the magnetizing dispenser of FIG. 18a showing fluid being poured out.

FIG. 18d is a top view of the magnet of FIG. 18b.

FIG. 18e is a top view of the magnet of FIG. 18b showing a level of the fluid when being poured out.

FIG. 19a is a view of the magnetizing dispenser of FIG. 15 with a point of the scale between the 12 and 3 O'clock positioned upward when pouring the fluid out of the bottle.

FIG. 19b is a perspective view of the magnet in the magnetizing dispenser of FIG. 19a.

FIG. 19c is a cross-sectional view of the magnetizing dispenser of FIG. 19a showing fluid being poured out.

FIG. 19d is a top view of the magnet of FIG. 19b.

FIG. 19e is a top view of the magnet of FIG. 19b showing a level of the fluid when being poured out.

FIG. 20a is a view of the magnetizing dispenser of FIG. 15 with the scale's 3 O'clock positioned upward when pouring the fluid out of the bottle.

FIG. 20b is a perspective view of the magnet in the magnetizing dispenser of FIG. 20a.

FIG. 20c is a cross-sectional view of the magnetizing dispenser of FIG. 20a showing fluid being poured out.

FIG. 20d is a top view of the magnet of FIG. 20b.

FIG. 20e is a top view of the magnet of FIG. 20b showing a level of the fluid when being poured out.

FIG. 21a is a view of the magnetizing dispenser of FIG. 15 with a point of the scale between the 3 and 6 O'clock positioned upward when pouring the fluid out of the bottle.

FIG. 21b is a perspective view of the magnet in the magnetizing dispenser of FIG. 21a.

FIG. 21c is a cross-sectional view of the magnetizing dispenser of FIG. 21a showing fluid being poured out.

FIG. 21d is a top view of the magnet of FIG. 21b.

FIG. 21e is a top view of the magnet of FIG. 21b showing a level of the fluid when being poured out.

FIG. 22a is a view of the magnetizing dispenser of FIG. 15 with the scale's 6 O'clock positioned upward when pouring the fluid out of the bottle.

FIG. 22b is a perspective view of the magnet in the magnetizing dispenser of FIG. 22a.

FIG. 22c is a cross-sectional view of the magnetizing dispenser of FIG. 22a showing fluid being poured out.

FIG. 22d is a top view of the magnet of FIG. 22b.

FIG. 22e is a top view of the magnet of FIG. 22b showing a level of the fluid when being poured out.

FIG. 23a is a view of the magnetizing dispenser of FIG. 15 with a point of the scale between the 6 and 9 O'clock positioned upward when pouring the fluid out of the bottle.

FIG. 23b is a perspective view of the magnet in the magnetizing dispenser of FIG. 23a.

FIG. 23c is a cross-sectional view of the magnetizing dispenser of FIG. 23a showing fluid being poured out.

FIG. 23d is a top view of the magnet of FIG. 23b.

FIG. 23e is a top view of the magnet of FIG. 23b showing a level of the fluid when being poured out.

FIG. 24 is a diagram showing the position of beverage in the magnetizing dispenser of FIG. 15 at different clock position.

FIG. 25a is a longitudinal sectional view of another embodiment of a magnetizing dispenser FIG. 25b is an exploded view of a magnet assembly in the magnetizing dispenser of FIG. 25a.

FIG. 26a is a longitudinal sectional view of another embodiment of a magnetizing dispenser.

FIG. 26b is an exploded view of a magnet assembly in the magnetizing dispenser of FIG. 26a.

FIG. 27a is a longitudinal sectional view of another embodiment of a magnetizing dispenser.

FIG. 27b is an exploded view of a magnet assembly in the magnetizing dispenser of FIG. 27a.

FIG. 28a is a longitudinal sectional view of another embodiment of a magnetizing dispenser.

FIG. 28b is an exploded view of a magnet assembly in the magnetizing dispenser of FIG. 28a.

FIG. 29a is a longitudinal sectional view of another embodiment of a magnetizing dispenser.

FIG. 29b is an exploded view of a magnet assembly in the magnetizing dispenser of FIG. 29a.

FIG. 30a is a longitudinal sectional view of another embodiment of a magnetizing dispenser.

FIG. 30b is an exploded view of a magnet assembly in the magnetizing dispenser of FIG. 30a.

FIG. 31a is a longitudinal sectional view of another embodiment of a magnetizing dispenser.

FIG. 31b is an exploded view of a magnet assembly in the magnetizing dispenser of FIG. 31a.

FIG. 32a is a longitudinal sectional view of another embodiment of a magnetizing dispenser.

FIG. 32b is an exploded view of a magnet assembly in the magnetizing dispenser of FIG. 32a.

FIG. 33a is a longitudinal sectional view of another embodiment of a magnetizing dispenser.

FIG. 33b is an exploded view of a magnet assembly in the magnetizing dispenser of FIG. 33a.

FIG. 34a is a longitudinal sectional view of another embodiment of a magnetizing dispenser.

FIG. 34b is an exploded view of a magnet assembly in the magnetizing dispenser of FIG. 34a.

FIG. 35a is a longitudinal sectional view of another embodiment of a magnetizing dispenser.

FIG. 35b is an exploded view of a magnet assembly in the magnetizing dispenser of FIG. 35a.

FIG. 36a is a longitudinal sectional view of another embodiment of a magnetizing dispenser.

FIG. 36b is an exploded view of a magnet assembly in the magnetizing dispenser of FIG. 36a.

FIG. 37a is a longitudinal sectional view of another embodiment of a magnetizing dispenser.

FIG. 37b is an exploded view of a magnet assembly in the magnetizing dispenser of FIG. 37a.

FIG. 38a is a longitudinal sectional view of another embodiment of a magnetizing dispenser.

FIG. 38b is an exploded view of a magnet assembly in the magnetizing dispenser of FIG. 38a.

FIG. 39a is a longitudinal sectional view of another embodiment of a magnetizing dispenser.

FIG. 39b is an exploded view of a magnet assembly in the magnetizing dispenser of FIG. 39a.

FIG. 40a is a longitudinal sectional view of another embodiment of a magnetizing dispenser.

FIG. 40b is an exploded view of a magnet assembly in the magnetizing dispenser of FIG. 40a.

FIG. 41a is a longitudinal sectional view of another embodiment of a magnetizing dispenser.

FIG. 41b is an exploded view of a magnet assembly in the magnetizing dispenser of FIG. 41a.

FIG. 42a is a longitudinal sectional view of another embodiment of a magnetizing dispenser.

FIG. 42b is an exploded view of a magnet assembly in the magnetizing dispenser of FIG. 42a.

FIG. 43a is a longitudinal sectional view of another embodiment of a magnetizing dispenser.

FIG. 43b is an exploded view of a magnet assembly in the magnetizing dispenser of FIG. 43a.

FIG. 44a is a longitudinal sectional view of another embodiment of a magnetizing dispenser.

FIG. 44b is an exploded view of a magnet assembly in the magnetizing dispenser of FIG. 44a.

FIG. 45a is a longitudinal sectional view of another embodiment of a magnetizing dispenser.

FIG. 45b is an exploded view of a magnet assembly in the magnetizing dispenser of FIG. 45a.

FIG. 46a is a longitudinal sectional view of another embodiment of a magnetizing dispenser.

FIG. 46b is an exploded view of a magnet assembly in the magnetizing dispenser of FIG. 46a.

FIG. 47 is a longitudinal sectional view of another embodiment of the magnetizing dispenser;

FIG. 48 is a longitudinal sectional view of another embodiment of the magnetizing dispenser; and

FIG. 49 is a longitudinal sectional view of another embodiment of the magnetizing dispenser.

### DETAILED DESCRIPTION OF THE PREFERRED EMBODIMENTS

For illustration purposes, the terms “upper”, “lower”, “right”, “left”, “vertical”, “horizontal”, “top”, “bottom” appeared hereinafter relate to the invention as it is oriented in the drawings. It is understood that the invention may assume various positions, except where expressly specified to the contrary. Furthermore, it is understood that the specific devices shown in the drawings, and described in the following description, are simply exemplary embodiments of the invention. Hence, specific dimensions and other physical characteristics related to the embodiments disclosed hereinafter are not to be considered as limiting.

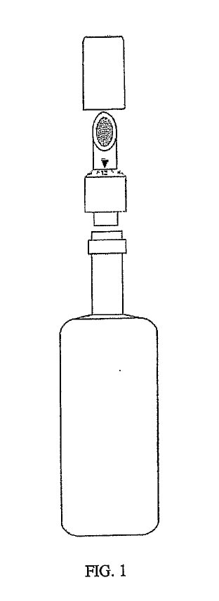

Referring now to the drawings, in which like reference numerals represent like parts throughout the drawings, FIG. 1 shows a bottle and a magnetizing dispenser with an end cap. The magnetizing dispenser is adapted to engage with the mouth of the bottle. The end cap is adapted to cover the opening end of the magnetizing dispenser.

For illustration purposes, the bottle is of a particular shape for a particular kind of beverage. However, it is appreciated that the magnetizing dispenser of can be used in association with many other kinds of containers for a large variety of beverages, such as wine, spirit, beer, coffee, tea, fruit juice, water, etc.

In the illustrated embodiment, the dispenser includes an adjustable spout with a pointer, a base mount with scale on the shoulder of the base mount and a bottle insert. The insert preferably includes a rubber seal. The dispenser can be plugged into to the mouth of the bottle. Preferably, the base mount is in a rotatable relationship with respect to the spout.

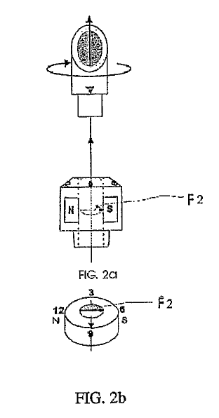

FIG. 2a shows an explode view of the magnetizing dispenser of FIG. 1, which includes an adjustable spout with a pointer and an insert mounted on a base mount. The base mount has a scale on its shoulder and an embedded magnet assembly. The scale in the illustrated embodiment is a clock style with 12 scales. It is to be understood that the scale can be other styles more or less than 12 scales.

Upon pouring beverage, the beverage flows through the hollow tube at the center of the dispenser. The adjustable spout can be rotated clockwise or anti-clockwise so that the orientation of the magnetic field cuts through the interface between the outgoing fluid and the incoming air flowing through the tube at different angles corresponding to different positions of the pointer on the scale.

FIG. 2b shows the perspective view of the embedded magnet in the magnetizing dispenser. In the illustrated embodiment, the magnetic field aligns between 12 o'clock and 6 o'clock position of the dispenser, which can be plugged into the mouth of the bottle. It is to be understood that the magnetic field may align between any other two positions, for example, between 1 o'clock and 7 o'clock or between 5 o'clock and 11 o'clock.

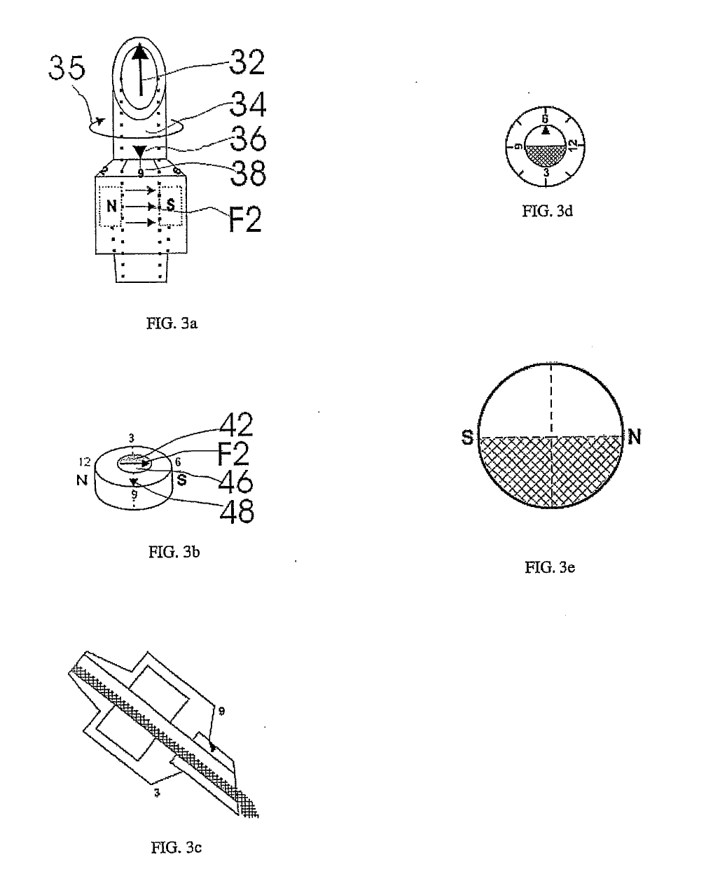

Referring to FIGS. 3a-3e, the adjustable spout 34 with the pointer 36 pointing at 9 o'clock position of the scale 6 and positioning upward when pouring the fluid out of the bottle. The magnetic field F2 cuts through the interface between the outgoing fluid 42 and the incoming air 46 flowing through the inner tubular cavity of the magnetizing dispenser at zero degree upon pouring of the fluid from the bottle. When pouring the fluid at this position, the dispenser can change the original flavor of the beverage to a different flavor. The spout can be adjusted clockwise 35 or anti-clockwise with respect to the direction of flow 32 of the fluid upon pouring.

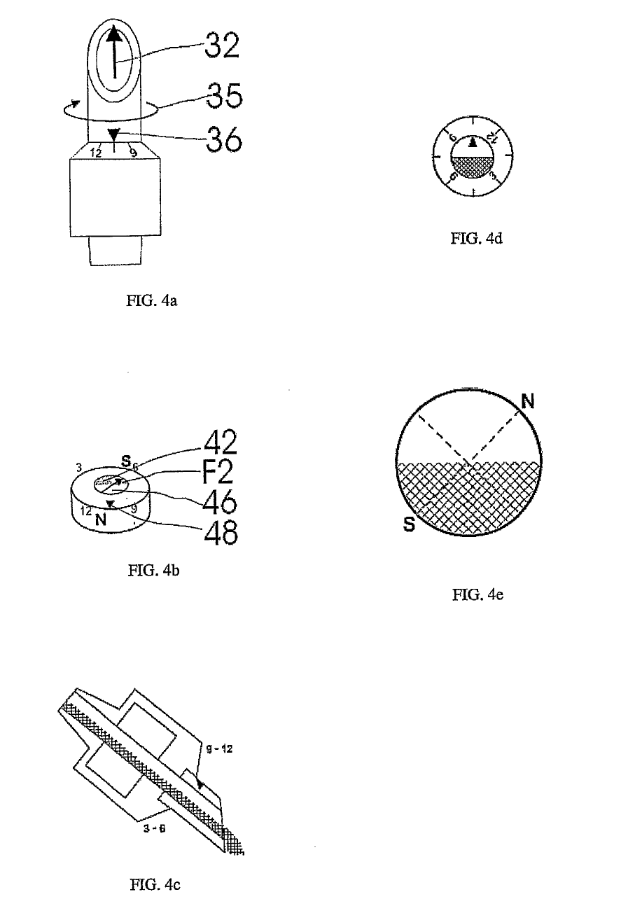

Referring to FIGS. 4a-4e, the adjustable spout 34 with the pointer 36 pointing between 9 and 12 o'clock positions of the scale 6 and positioning upward when pouring the fluid out of the bottle. The magnetic field F2 cuts through the interface between the outgoing fluid 42 and the incoming air 46 flowing through the inner tubular cavity of the magnetizing dispenser at 45 degree upon pouring of the fluid from the bottle. When pouring the fluid at this position, the dispenser can change the original flavor of the beverage to a different flavor. The spout can be rotated clockwise 35 or anti-clockwise with respect to the direction of flow 32 of the fluid upon pouring.

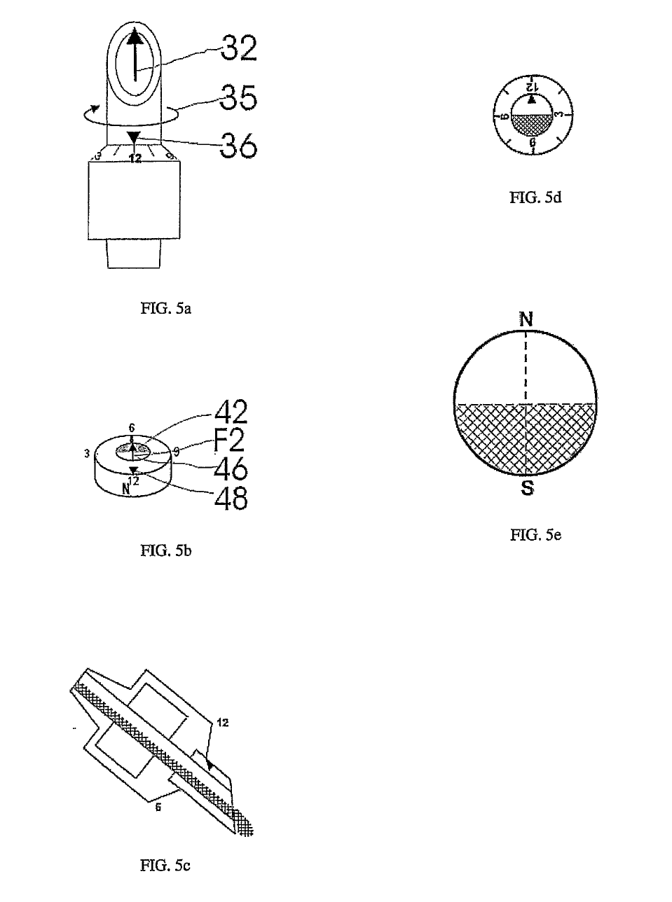

Referring to FIGS. 5a-5e, the adjustable spout 34 with the pointer 36 pointing at 12 o'clock position of the scale 6 and positioning upward when pouring the fluid out of the bottle. The magnetic field F2 cuts through the interface between the outgoing fluid 42 and the incoming air 46 flowing through the inner tubular cavity of the magnetizing dispenser at 90 degree upon pouring of the fluid from the bottle. When pouring the fluid at this position, the dispenser can change the original flavor of the beverage to a different flavor. The spout can be rotated clockwise 35 or anti-clockwise with respect to the direction of flow 32 of the fluid upon pouring.

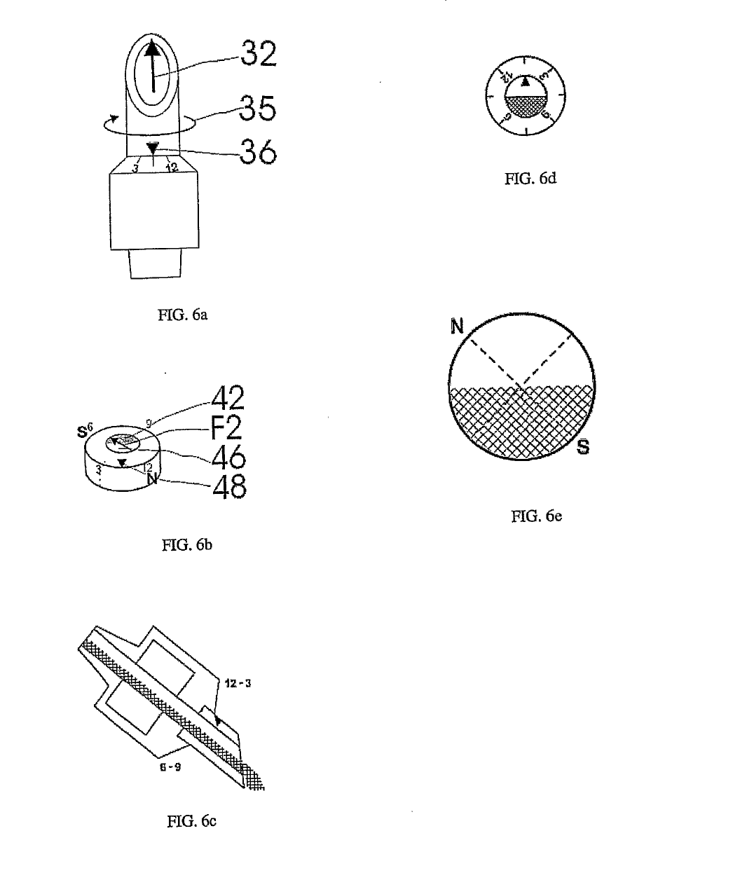

Referring to FIGS. 6a-6e, the adjustable spout 34 with the pointer 36 pointing between 12 and 3 o'clock positions of the scale 6 and positioning upward when pouring the fluid out of the bottle. The magnetic field F2 cuts through the interface between the outgoing fluid 42 and the incoming air 46 flowing through the inner tubular cavity of the magnetizing dispenser at 135 degree upon pouring of the fluid from the bottle. When pouring the fluid at this position, the dispenser can change the original flavor of the beverage to a different flavor. The spout can be rotated clockwise 35 or anti-clockwise with respect to the direction of flow 32 of the fluid upon pouring.

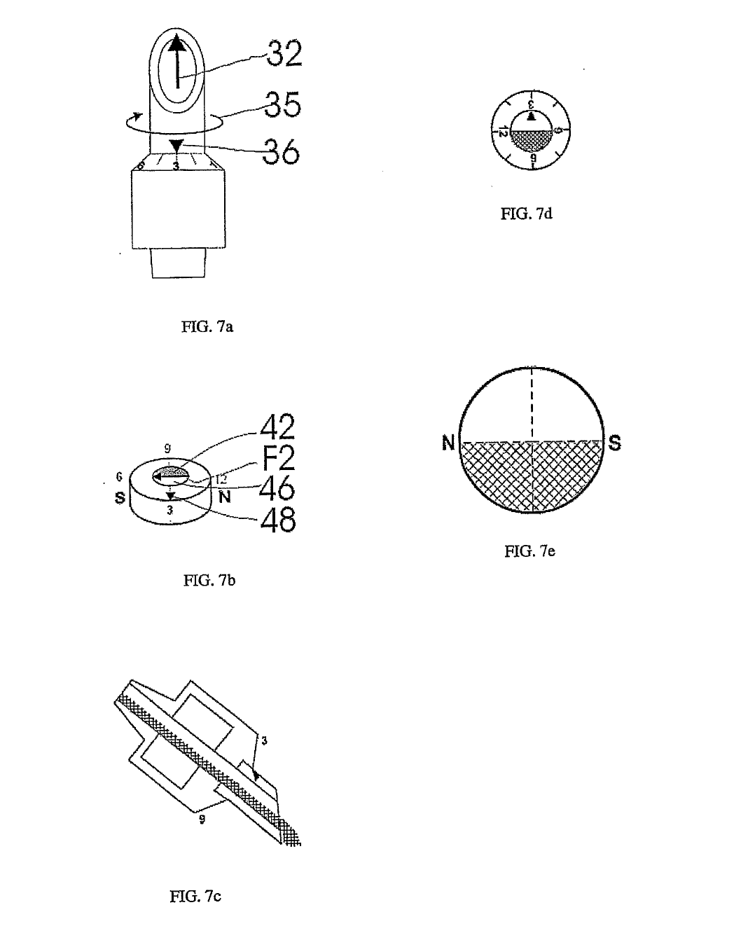

Referring to FIGS. 7a-7e, the adjustable spout 34 with the pointer 36 pointing at 3 o'clock position of the scale 6 and positioning upward when pouring the fluid out of the bottle. The magnetic field F2 cuts through the interface between the outgoing fluid 42 and the incoming air 46 flowing through the inner tubular cavity of the magnetizing dispenser at 180 degree upon pouring of the fluid from the bottle. When pouring the fluid at this position, the dispenser can change the original flavor of the beverage to a different flavor. The dispenser can be adjusted clockwise 35 or anti-clockwise with respect to the direction of flow 32 of the fluid upon pouring.

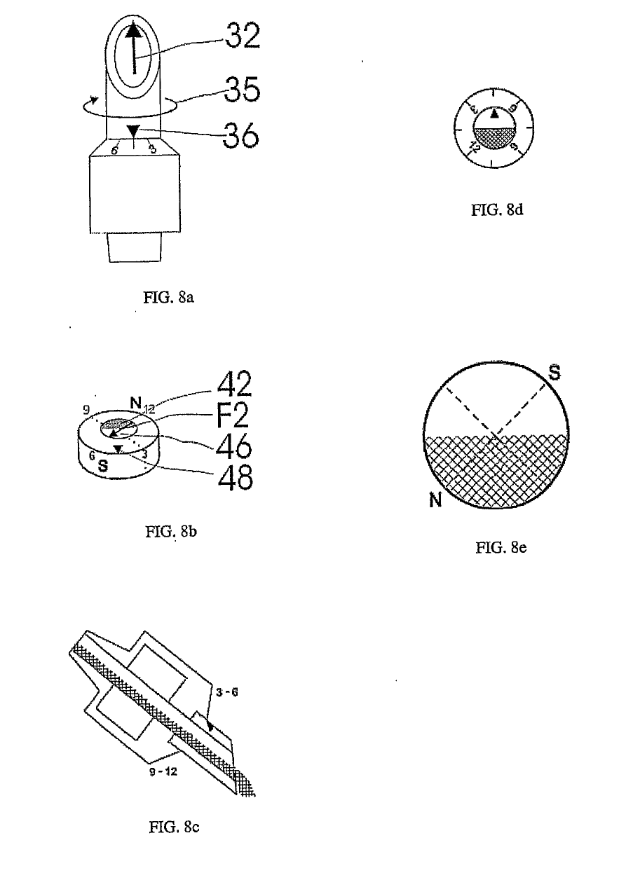

Referring to FIGS. 8a-8e, the adjustable spout 34 with the pointer 36 pointing between 3 and 6 o'clock positions of the scale 6 and positioning upward when pouring the fluid out of the bottle. The magnetic field F2 cuts through the interface between the outgoing fluid 42 and the incoming air 46 flowing through the inner tubular cavity of the magnetizing dispenser at 225 degree upon pouring of the fluid from the bottle. When pouring the fluid at this position, the dispenser can change the original flavor of the beverage to a different flavor. The dispenser can be rotated clockwise 35 or anti-clockwise with respect to the direction of flow 32 of the fluid upon pouring.

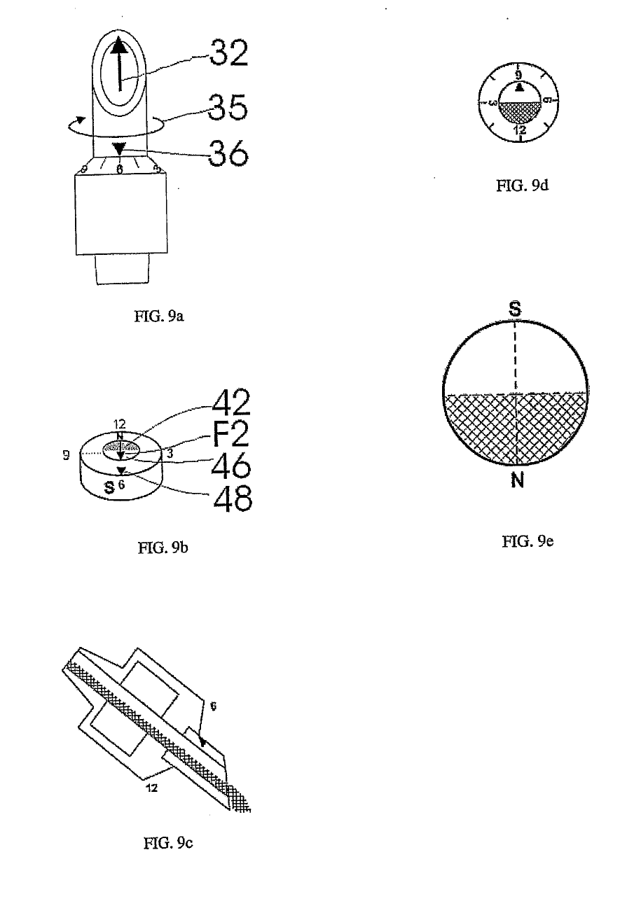

Referring to FIGS. 9a-9e, the adjustable spout 34 with the pointer 36 pointing at 6 o'clock position of the scale 6 and positioning upward when pouring the fluid out of the bottle. The magnetic field F2 cuts through the interface between the outgoing fluid 42 and the incoming air 46 flowing through the inner tubular cavity of the magnetizing dispenser at 270 degree upon pouring of the fluid from the bottle. When pouring the fluid at this position, the dispenser can change the original flavor of the beverage to a different flavor. The spout can be rotated clockwise 35 or anti-clockwise with respect to the direction of flow 32 of the fluid upon pouring.

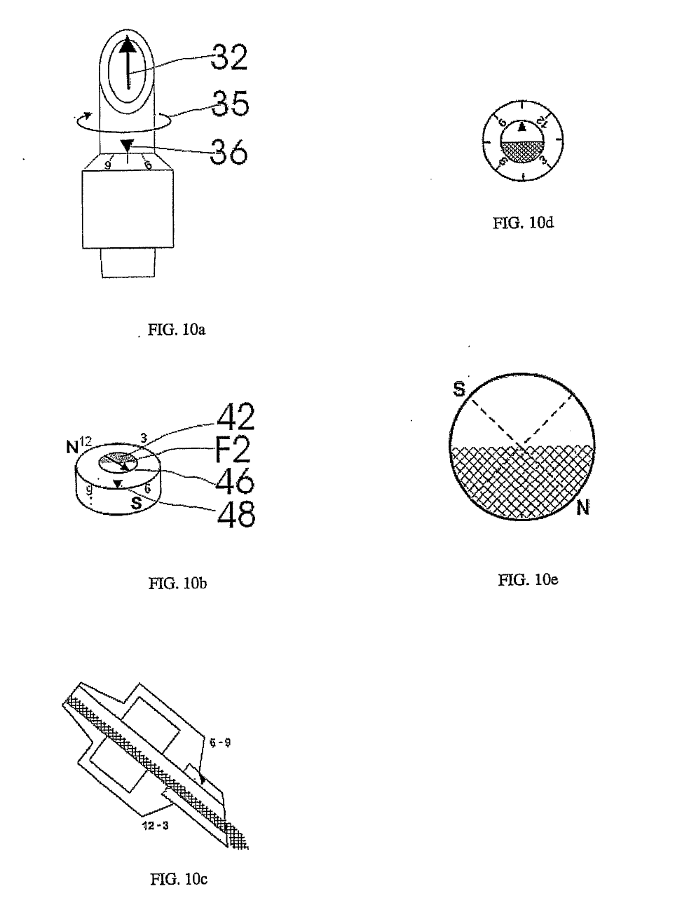

Referring to FIGS. 10a-10e, the adjustable spout 34 with the pointer 36 pointing between 6 and 9 o'clock positions of the scale 6 and positioning upward when pouring the fluid out of the bottle. The magnetic field F2 cuts through the interface between the outgoing fluid 42 and the incoming air 46 flowing through the inner tubular cavity of the magnetizing dispenser at 315 degree upon pouring of the fluid from the bottle. When pouring the fluid at this position, the dispenser can change the original flavor of the beverage to a different flavor. The spout can be rotated clockwise 35 or anti-clockwise with respect to the direction of flow 32 of the fluid upon pouring.

Although the pointer 36 of the adjustable spout 34 points to only certain positions on the dial as shown in FIGS. 3-10, it is to be understood that the pointer 36 can point to any position on the dial to change the original flavor of the beverage to different flavors.

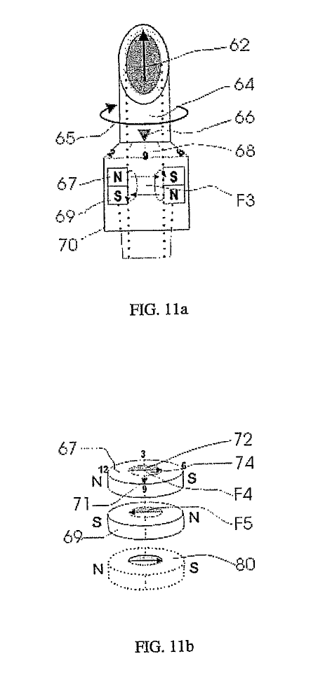

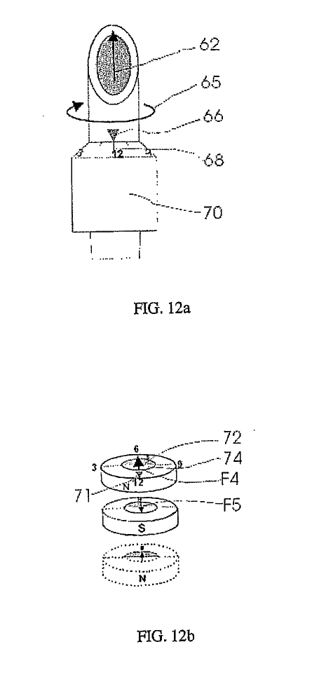

FIGS. 11a and 12a are front views of another embodiment of a magnetizing dispenser with an adjustable spout. The spout can be rotated clockwise 65 or anti-clockwise with respect to the direction of flow 62 of the fluid upon pouring. The base mount of the dispenser 70 can be embedded with one or more magnets.

FIGS. 11b and 12b are perspective views of the magnets of the magnetizing dispenser of FIGS. 11a and 12a, respectively. In the illustrated embodiment, the magnetic field F4, F5 cut through the interface between the outgoing fluid 72 and the incoming air 74 flowing through the inner tubular cavity of the magnetizing dispenser at a certain degree upon pouring of the fluid from the bottle. Additional magnets 80 can be embedded into the base mount of the dispenser.

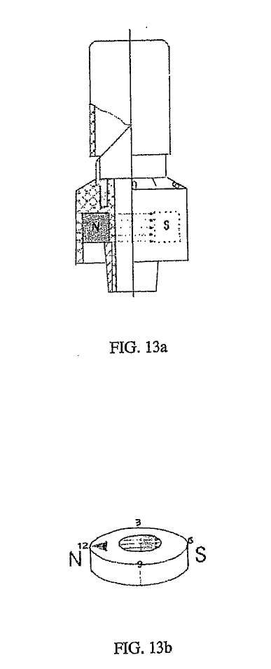

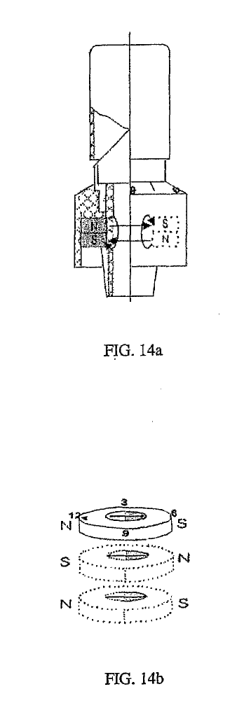

FIG. 13a is a front/cross-sectional view of a magnetizing dispenser of FIG. 3a showing the internal structure of the dispenser. FIG. 13b is a perspective view of the magnet of the magnetizing dispenser of FIG. 13a. FIG. 14a is a front/cross-sectional view of a magnetizing dispenser of FIG. 11a showing the internal structure of the dispenser. FIG. 14b is a perspective view of the magnet of the magnetizing dispenser of FIG. 14a. The dispensers of FIGS. 13a and 14a each include a cap.

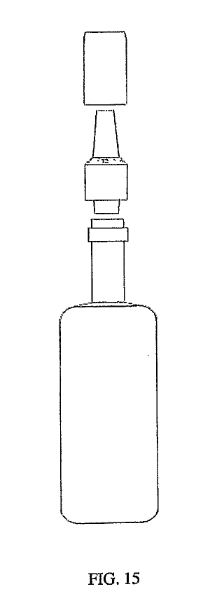

FIG. 15 is a view of a bottle and a magnetizing dispenser with a fixed spout in accordance with another embodiment. In the present embodiment, the magnetic field F37 aligns between 12 o'clock and 6 o'clock positions of the dispenser, which can be plugged into the mouth of the bottle. It is to be understood that the magnetic field F37 may align between any other two positions, for example, between 1 o'clock and 7 o'clock or between 5 o'clock and 11 o'clock. The scale in the illustrated embodiment is a clock style with 12 scales. It is to be understood that the scale can be other styles more or less than 12 scales.

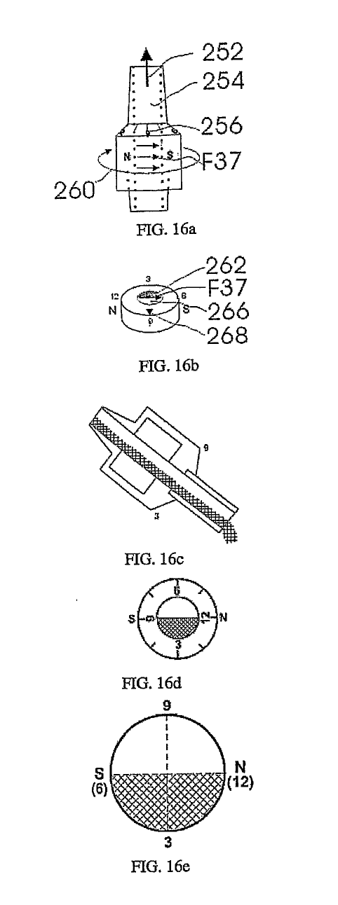

Referring to FIGS. 16a-16e, the point at the 9 o'clock of the fixed spout 254 is positioned upward when pouring the fluid out of the bottle. The magnetic field F2 cuts through the interface between the outgoing fluid 262 and the incoming air 266 flowing through the inner tubular cavity of the magnetizing dispenser at zero degree upon pouring of the fluid from the bottle. When pouring the fluid at this position, the dispenser can change the original flavor of the beverage to a different flavor.

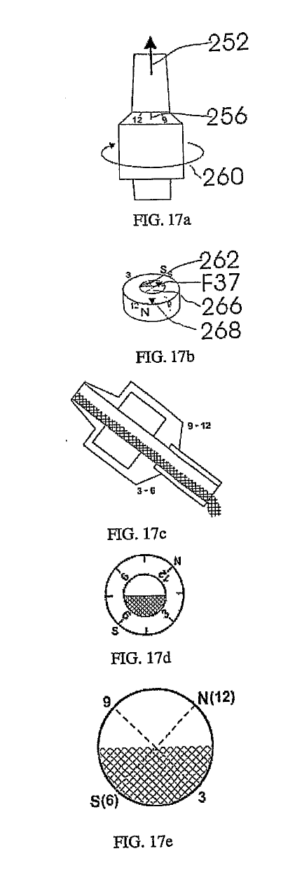

Referring to FIGS. 17a-17e, the center point between 9 o'clock and 12 o'clock of the fixed spout 254 is positioned upward when pouring the fluid out of the bottle. The magnetic field F2 cuts through the interface between the outgoing fluid 262 and the incoming air 266 flowing through the inner tubular cavity of the magnetizing dispenser at 45 degrees upon pouring of the fluid from the bottle. When pouring the fluid at this position, the dispenser can change the original flavor of the beverage to a different flavor.

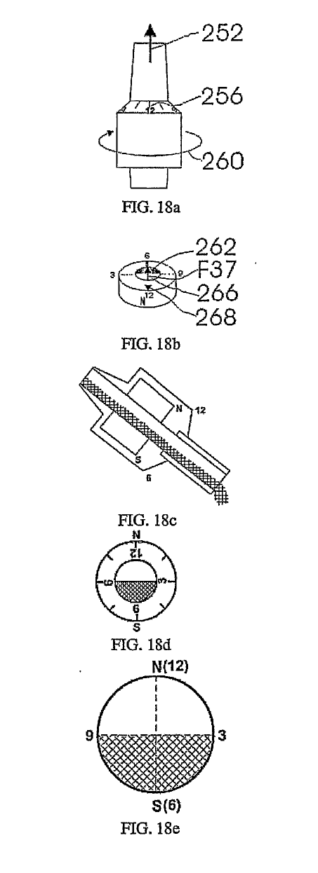

Referring to FIGS. 18a-18e, the point at the 12 o'clock of the fixed spout 254 is positioned upward when pouring the fluid out of the bottle. The magnetic field F2 cuts through the interface between the outgoing fluid 262 and the incoming air 266 flowing through the inner tubular cavity of the magnetizing dispenser at 90 degrees upon pouring of the fluid from the bottle. When pouring the fluid at this position, the dispenser can change the original flavor of the beverage to a different flavor.

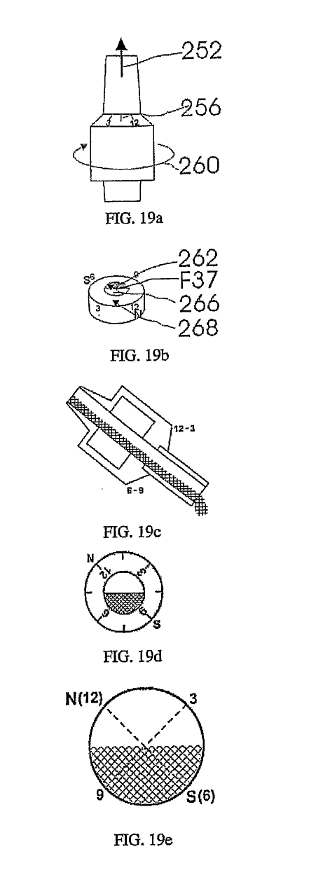

Referring to FIGS. 19a-19e, the center point between 12 o'clock and 3 o'clock of the fixed spout 254 is positioned upward when pouring the fluid out of the bottle. The magnetic field F2 cuts through the interface between the outgoing fluid 262 and the incoming air 266 flowing through the inner tubular cavity of the magnetizing dispenser at 135 degrees upon pouring of the fluid from the bottle. When pouring the fluid at this position, the dispenser can change the original flavor of the beverage to a different flavor.

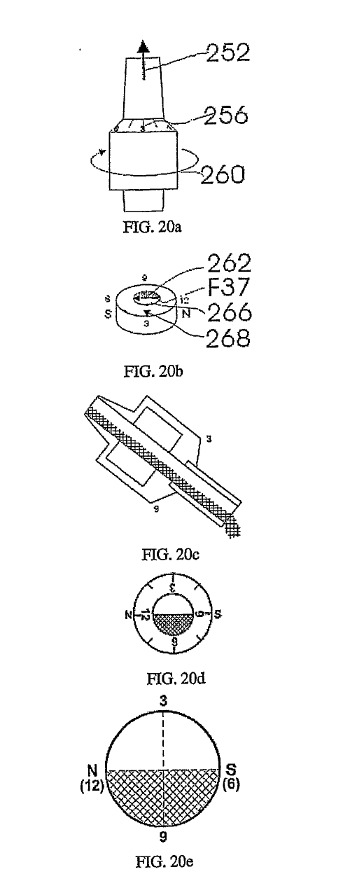

Referring to FIGS. 20a-20e, the point at the 3 o'clock of the fixed spout 254 is positioned upward when pouring the fluid out of the bottle. The magnetic field F2 cuts through the interface between the outgoing fluid 262 and the incoming air 266 flowing through the inner tubular cavity of the magnetizing dispenser at 180 degrees upon pouring of the fluid from the bottle. When pouring the fluid at this position, the dispenser can change the original flavor of the beverage to a different flavor.

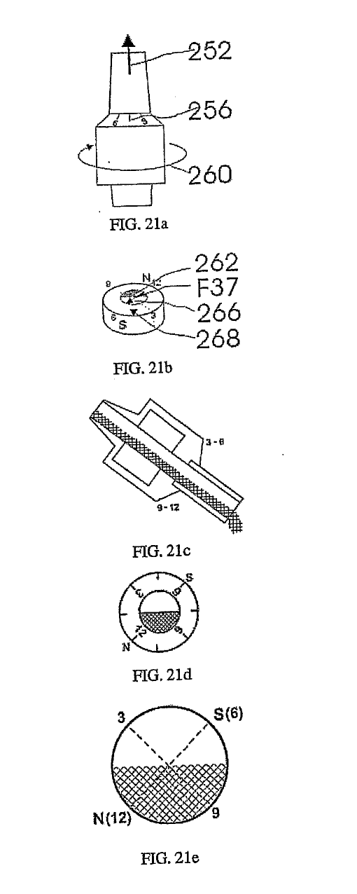

Referring to FIGS. 21a-21e, the center point between 3 o'clock and 6 o'clock of the fixed spout 254 is positioned upward when pouring the fluid out of the bottle. The magnetic field F2 cuts through the interface between the outgoing fluid 262 and the incoming air 266 flowing through the inner tubular cavity of the magnetizing dispenser at 225 degrees upon pouring of the fluid from the bottle. When pouring the fluid at this position, the dispenser can change the original flavor of the beverage to a different flavor.

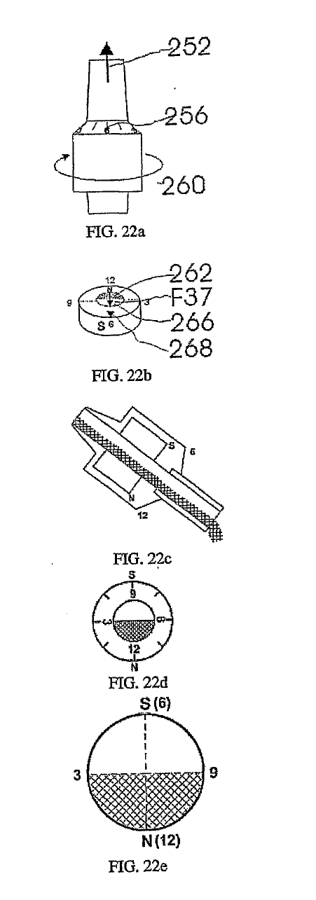

Referring to FIGS. 22a-22e, the point at the 6 o'clock of the fixed spout 254 is positioned upward when pouring the fluid out of the bottle. The magnetic field F2 cuts through the interface between the outgoing fluid 262 and the incoming air 266 flowing through the inner tubular cavity of the magnetizing dispenser at 270 degrees upon pouring of the fluid from the bottle. When pouring the fluid at this position, the dispenser can change the original flavor of the beverage to a different flavor.

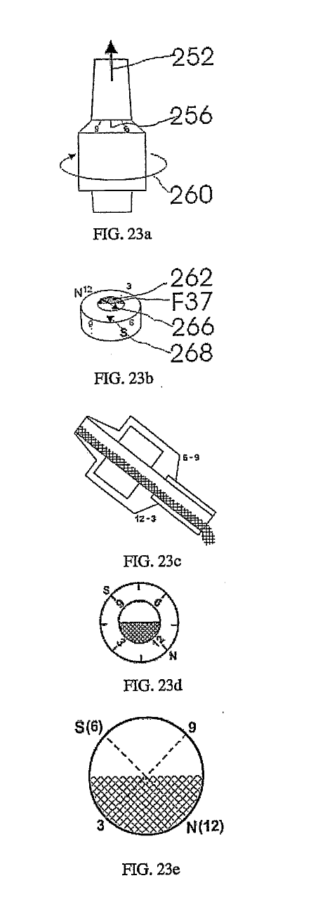

Referring to FIGS. 23a-23e, the center point between 6 o'clock and 9 o'clock of the fixed spout 254 is positioned upward when pouring the fluid out of the bottle. The magnetic field F2 cuts through the interface between the outgoing fluid 262 and the incoming air 266 flowing through the inner tubular cavity of the magnetizing dispenser at 315 degrees upon pouring of the fluid from the bottle. When pouring the fluid at this position, the dispenser can change the original flavor of the beverage to a different flavor.

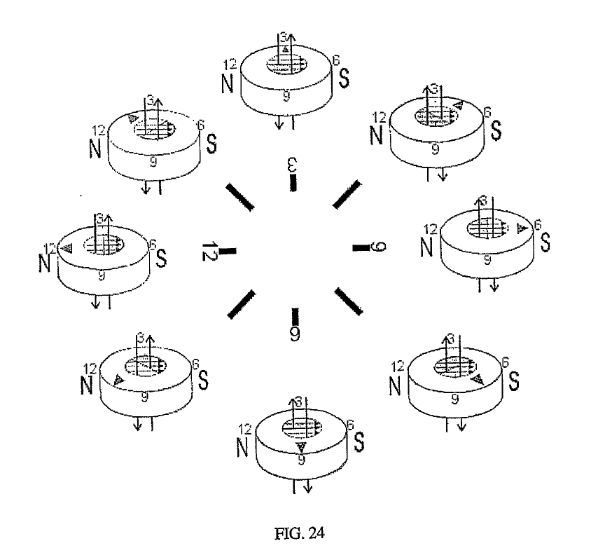

FIG. 24 shows the orientation of the magnetic field rotating with the bottle with different scale readings pointing upward upon pouring. The magnetic field cuts the interface of the outgoing fluid 270 and incoming air 274 at different angles with respect to corresponding readings pointing upwards upon pouring. Although FIGS. 16-23 only show eight positions of the fixed spout 254 when pouring the liquid from the bottle, it is to be understood that the fixed spout 254 can be placed at any other positions to pour the liquid to change the original flavor of the beverage to different flavors.

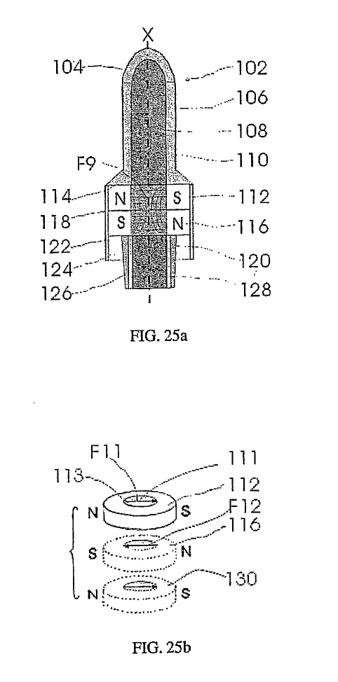

FIG. 25a is a longitudinal sectional view of another embodiment of a magnetizing dispenser. The magnetizing dispenser 102 includes a generally tubular body generally represented by reference numeral 110. The tubular body or conduit 110 defines therein a flow through opening or chamber 108, and a central longitudinal axis X. The tubular body 110 has an upper portion 106 and a lower portion 128. The upper portion 106 of the tubular body 110 has a slanted opening end 104.

The lower portion 128 of the tubular body 110 defines a bottle insert 126 which is adapted to be inserted into the mouth of the bottle. A generally cylindrical seal 120 may be affixed on the outer circumference of the bottle insert 126 for frictional engagement with the mouth of the bottle when the bottle insert 126 is inserted therein. The outer surface of the seal 120 may be slightly tapered towards the bottom end of the bottle insert 126 to facilitate the insertion of the bottle insert 126 into the mouth of the bottle and the sealing of the bottle. Preferably, the seal 120 can be made of rubber or any other suitable materials.

A compartment, preferably an annular compartment, generally designated by reference numeral 118, is provided on the outer circumference of the tubular body 110 proximate to the lower portion 126 thereof. According to the present embodiment, the compartment 118 is located adjacent to and above the bottle insert 126. The compartment 118 may have a shoulder 144 and a skirt 122. The shoulder 114 and the skirt 122 together define a cavity or recess 124 for receiving therein magnets which will be described below in detail.

The tubular body 110 and the compartment 118 can be made of non-magnetic shielding material such as plastics, aluminum, copper, or any other suitable materials.

According to another embodiment, the magnet assembly includes at least one magnet, namely a first magnet 112. A second magnet 116 and additional plurality of magnets 130 can be added. Each of the two magnets 112, 116 is in the form of a dipole ring magnet, as depicted in FIG. 25b. The two ring magnets 112, 116 can be of the same dimensions. The two dipole ring magnets 112, 116 may be embedded and secured in the annular recess 124. The two dipole ring magnets 112, 116 are positioned one on top of the other in such a manner that the north magnetic pole of the first magnet 112 is directly opposite to the south magnetic pole of the second magnet 116, and that the south magnetic pole of the first magnet 112 is directly opposite to the north magnetic pole of the second magnet 116, as best shown in FIG. 25a.

It is instructive to note that, when the two dipole ring magnets 112, 116 are polarized and arranged in this fashion, the two magnets 112, 116 are held together due to their magnetic forces of attraction, as is well known.

In the illustrated embodiment, when the two dipole ring magnets 112, 116 are embedded in the annular recess 124, the inner cylindrical surfaces of the two ring magnets 112, 116 may be substantially flush with the inner cylindrical surface of the magnetizing dispenser. The outer cylindrical surfaces of the two ring magnets 112, 116 may abut against the inner cylindrical surface of the annular compartment 118. The top surface of the top ring magnet 112 may abut against the bottom surface of the annular shoulder 114. The bottom surface of the bottom ring magnet 116 may abut against the top end of the bottle insert 126.

The two dipole ring magnets 112, 116 impart magnetic fields which extend into the flow through opening 108 of the magnetizing dispenser. The directions of the magnetic fields within the dispenser are conventionally expressed by wavy and horizontal flux paths or lines F9, as depicted in FIG. 25a.

Although it has been shown that there are two dipole ring magnets 112, 116 in the magnetizing dispenser, it is appreciated the number and size of the ring magnets may be increased to produce a stronger magnetic field, if desired.

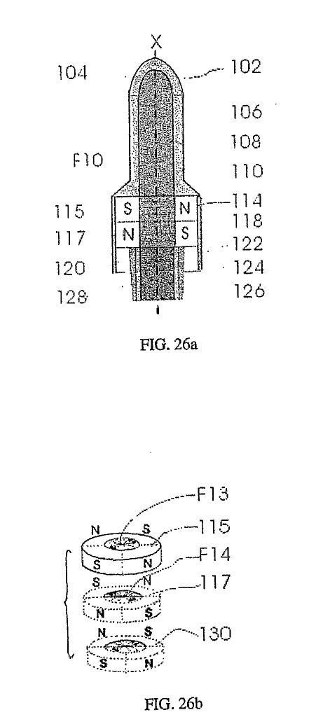

FIGS. 26a and 26b show another embodiment of the magnet assembly of the magnetizing dispenser. According to this embodiment, the magnet assembly may include at least two magnets, namely a first magnet 115 and a second magnet 117. A third magnet or more magnets may be added. Each of the two magnets 115, 117 takes the form of a multipole ring magnet. The two multipole ring magnets 115, 117 are disposed one on top of the other in such a manner that the two north magnetic poles of the first magnet 115 are directly opposite to the two south magnetic poles of the second magnet 117 respectively, and that the two south magnetic poles of the first magnet 115 are directly opposite to the two north magnetic poles of the second magnet 117 respectively.

When the two multipole ring magnets 115, 117 are embedded in the annular recess 124, the inner cylindrical surfaces of the two ring magnets 115, 117 may be substantially flush with the inner cylindrical surface of the magnetizing dispenser.

The two multipole ring magnets 115, 117 impart magnetic fields which extend into the flow through opening 108 of the magnetizing dispenser. The directions of the magnetic fields within the dispenser are represented by flux lines F10, as depicted in FIG. 26a.

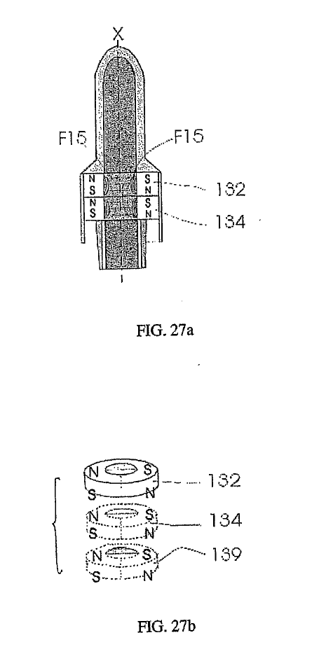

FIGS. 27a and 27b show another embodiment of the magnet assembly of the magnetizing dispenser. According to this embodiment, the magnet assembly may include at least two magnets, namely a first magnet 132 and a second magnet 134. A third magnet 139 or more magnets may be added.

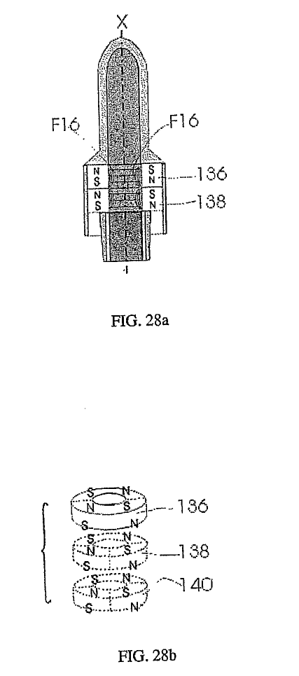

FIGS. 28a and 28b show another embodiment of the magnet assembly of the magnetizing dispenser. According to this embodiment, the magnet assembly may include at least two magnets, namely a first magnet 136 and a second magnet 138. A third magnet 140 or more magnets may be added.

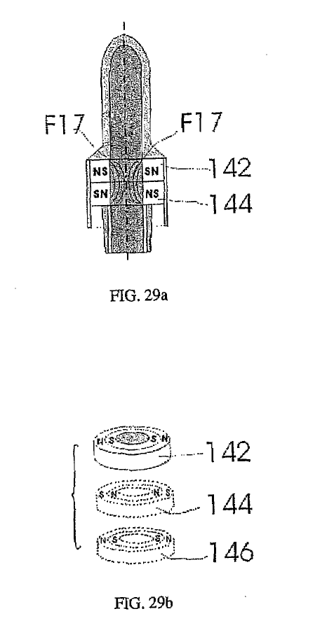

FIGS. 29a and 29b show another embodiment of the magnet assembly of the magnetizing dispenser. According to this embodiment, the magnet assembly includes at least two magnets, namely a first magnet 142 and a second magnet 144. A third magnet 146 or more magnets may be added. The first magnet 142 may have radial polarity with an inner south magnetic pole and a concentric outer north magnetic pole. The second magnet 144 may have radial polarity with an inner north magnetic pole and a concentric outer south magnetic pole.

In use, the first ring magnet 142 may be disposed on top of the second ring magnet 144 in such a manner that the outer north magnetic pole of the first magnet 142 is directly opposite to the outer south magnetic pole of the second magnet 144, and that the inner south magnetic pole of the first magnet 142 may be directly opposite to the inner north magnetic pole of the second magnet 144, as best shown in FIG. 29a.

When the two ring magnets 142, 144 are embedded in the annular recess 124, the inner cylindrical surfaces of the two ring magnets 142, 144 may be substantially flush with the inner cylindrical surface of the magnetizing dispenser.

The two ring magnets 142, 144 impart magnetic fields which extend into the flow through opening 108 of the magnetizing dispenser. Wavy flux lines F17, as depicted in FIG. 29a, express the directions of the magnetic fields within the magnetizing dispenser.

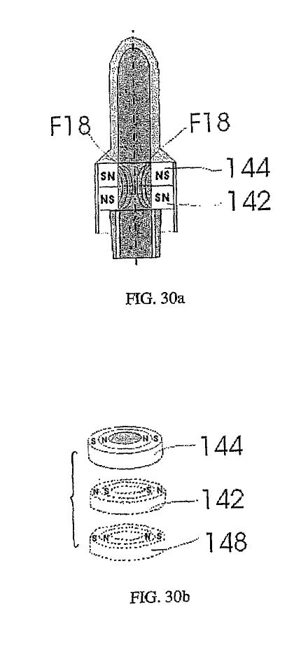

FIGS. 30a and 30b show another embodiment of the magnet assembly of the magnetizing dispenser. According to this embodiment, the magnet assembly includes at least two magnets, namely a first magnet 144 and a second magnet 142. A third magnet 148 or more magnets may be added. The first magnet 144, which is the same magnet 144 in FIGS. 29a and 29b, has radial polarity with inner north magnetic pole and outer south magnetic pole. The second magnet 144, which is the same magnet 142 in FIGS. 29a and 29b, has radial polarity with inner south magnetic pole and outer north magnetic pole.

The first ring magnet 144 may be disposed on top of the second ring magnet 142 in such a manner that the inner north magnetic pole of the first magnet 144 is directly opposite to the inner south magnetic pole of the second magnet 142, and that the outer south magnetic pole of the first magnet 144 may be directly opposite to the outer north magnetic pole of the second magnet 142, as best shown in FIG. 30a.

When the two ring magnets 144, 142 are embedded in the annular recess 124, the inner cylindrical surfaces of the two ring magnets 144, 142 may be substantially flush with the inner cylindrical surface of the magnetizing dispenser.

The two ring magnets 144, 142 impart magnetic fields which extend into the flow through opening 108 of the magnetizing dispenser. The directions of the magnetic fields within the dispenser are illustrated by flux lines F28, as depicted in FIG. 30a.

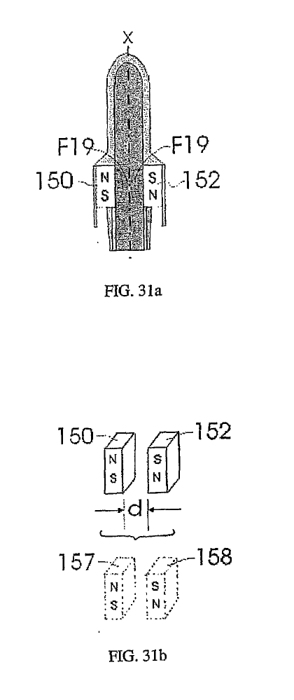

FIGS. 31a and 31b show another embodiment of the magnet assembly of the magnetizing dispenser. According to this embodiment, the magnet assembly includes at least two magnets, namely a first magnet 150 and a second magnet 152. The first magnet 150 may be in the form of a rectangular dipole magnet having upper north magnetic pole and lower south magnetic pole. The second magnet 152 may be in the form of a rectangular dipole magnet having upper south magnetic pole and lower north magnetic pole.

The first and second magnets 150, 152 having the same dimensions, may be disposed one opposite to the other within the annular recess 124 in such a manner that the upper north magnetic pole of the first magnet 150 is opposite to the upper south magnetic pole of the second magnet 152, and that the lower south magnetic pole of the first magnet 150 is opposite to the lower north magnetic pole of the second magnet 152, as best shown in FIG. 31a. The distance d between the two opposite magnets 150, 152 may equal to the diameter of the flow through opening 108 of the magnetizing dispenser.

The two rectangular magnets 150, 152 impart magnetic fields which extend into the flow through opening 108 of the magnetizing dispenser. The wavy and horizontal flux lines F29, as depicted in FIG. 31a, express the directions of the magnetic fields within the magnetizing dispenser.

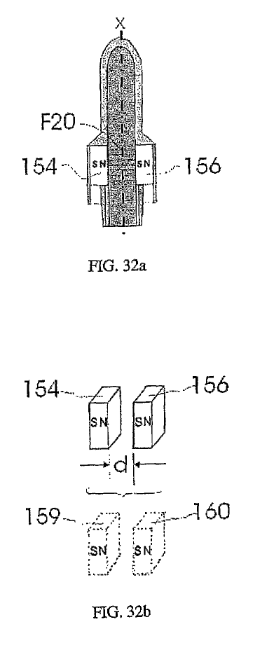

FIGS. 32a and 32b show another embodiment of the magnet assembly of the magnetizing dispenser. According to this embodiment, the magnet assembly includes at least two magnets, namely a first magnet 154 and a second magnet 156. The first magnet 154 may be in the form of a rectangular dipole magnet having inner north magnetic pole and outer south magnetic pole. The second magnet 156 is in the form of a rectangular dipole magnet having inner south magnetic pole and outer north magnetic pole.

The first and second magnets 154, 156 maybe disposed one opposite to the other within the annular recess 124 in such a manner that the inner north magnetic pole of the first magnet 154 is opposite to the inner south magnetic pole of the second magnet 156, as best shown in FIG. 32a.

The two magnets 154, 156 impart magnetic fields which extend into the flow through opening 108 of the magnetizing dispenser. The direction of the magnetic field within the magnetizing dispenser is only horizontal and is expressed by flux lines F20, as depicted in FIG. 32a.

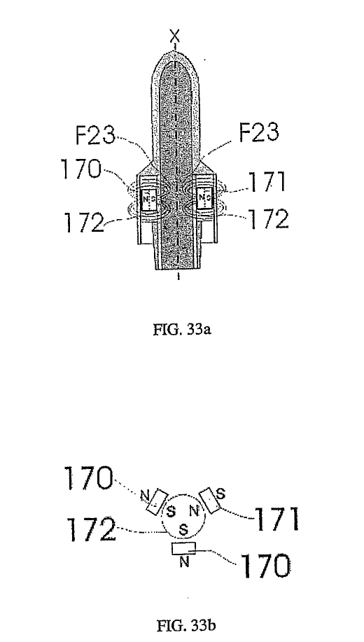

FIGS. 33a and 33b show another embodiment of the magnet assembly of the magnetizing dispenser. According to this embodiment, the magnet assembly may include two cylindrical dipole magnet 170 having south magnetic pole facing the inner cavity of the conduit and a cylindrical dipole magnets 171 having north magnetic pole facing the inner cavity of the conduit. The three dipole magnets 170 and 171 may be disposed around the outer circumference of the inner cylindrical wall 172 of the conduit generally equally spaced intervals of 120 degrees.

When the cylindrical magnet assembly 170 and 171 is embedded in the recess 124, the inner cylindrical wall 172 of the conduit may be substantially flush with the inner cylindrical surface of the magnetizing dispenser.

The cylindrical magnets 170 and 171 impart magnetic fields which extend into the flow through opening 108 of the magnetizing dispenser. A plurality of wavy flux lines F23, as depicted in FIG. 33a, represents the directions of the magnetic fields within the magnetizing dispenser.

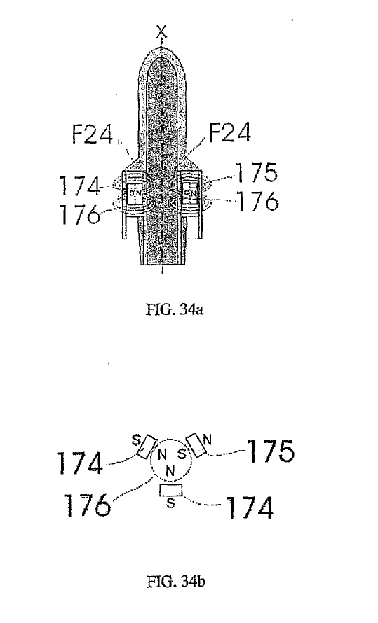

FIGS. 34a and 34b show another embodiment of the magnet assembly of the magnetizing dispenser. According to this embodiment, the magnet assembly may include two cylindrical dipole magnet 174 having north magnetic pole facing the inner cavity of the conduit and a cylindrical dipole magnets 175 having south magnetic pole facing the inner cavity of the conduit. The three dipole magnets 174 and 175 may be disposed around the outer circumference of the inner cylindrical wall 176 of the conduit generally equally spaced intervals of 120 degrees.

When the cylindrical magnet assembly 174 and 175 are embedded in the annular recess 124, the inner cylindrical wall 176 of the conduit may be substantially flush with the inner cylindrical surface of the magnetizing dispenser.

The cylindrical magnets 174 and 175 impart magnetic fields which extend into the flow through opening 108 of the magnetizing dispenser. A plurality of wavy flux lines F24, as depicted in FIG. 34a, represents the directions of the magnetic fields within the magnetizing dispenser.

Although it has been described in the twenty third and the twenty fourth embodiments that each of the cylindrical magnets 170, 171, 174 and 175 are disposed at equally spaced intervals of 120 degrees, it is understood that each of the cylindrical magnets 170, 171, 174 and 175 may be provided with any suitable number of magnets. For example, the cylindrical magnet 170 and 171 or 174 and 175 may be provided with two circumferentially spaced magnets disposed at equally spaced intervals of 180 degrees; or the cylindrical magnets 170 and 171 or 174 and 175 may provided with four circumferentially spaced magnets disposed at equally spaced intervals of 90 degrees.

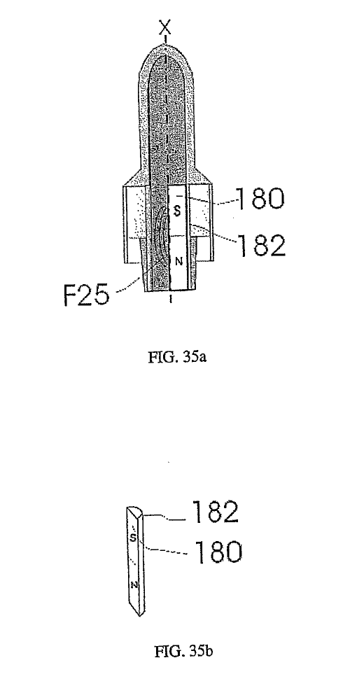

FIGS. 35a and 35b show another embodiment of the magnet assembly of the magnetizing dispenser. According to this embodiment, the magnet assembly may be in the form of a semi-cylindrical column dipole magnet 180, of semi-circular cross section, having south magnetic pole at the upper half thereof and north magnetic pole at the lower half thereof.

The semi-cylindrical surface 182 of the semi-cylindrical magnet 180 may be abutted against and affixed to the inner cylindrical surface of the magnetizing dispenser. According to the present embodiment, the magnet 180 extends along the entire length of the annular compartment 118 and along the entire length of the bottle insert 126 in such a manner that the upper half of the magnet 180 is adjacent to the annular recess 124 and the lower half of the magnet 180 is adjacent to the bottle insert 126. Flux lines F25, as depicted in FIG. 35a, denote the directions of the magnetic field within the magnetizing dispenser.

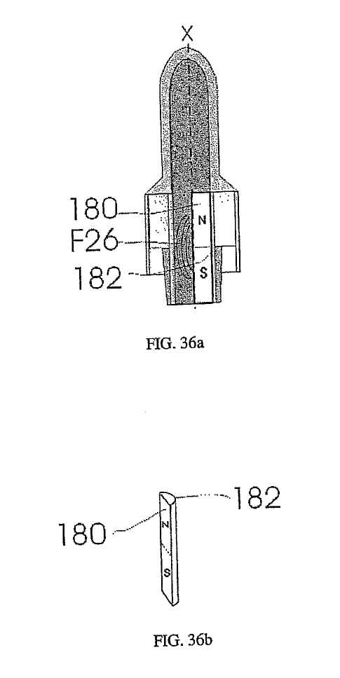

FIGS. 36a and 36b show another embodiment of the magnet assembly of the magnetizing dispenser. According to this embodiment, the magnet assembly is the same semi-cylindrical column dipole magnet 180 in FIGS. 35a and 35b but up side down such that the north magnetic pole is located at the upper half thereof and the south magnetic pole is located at the lower half thereof.

Similarly, the semi-cylindrical surface 182 of the semi-cylindrical magnet 180 may be abutted against and affixed to the inner cylindrical surface of the magnetizing dispenser. The direction of the magnetic field within the magnetizing dispenser is denoted by flux lines F26, as depicted in FIG. 36a.

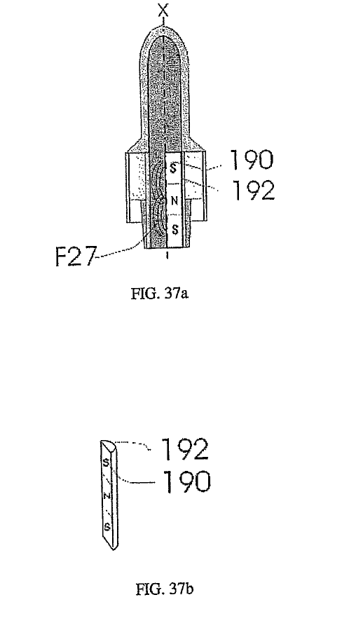

FIGS. 37a and 37b show another embodiment of the magnet assembly of the magnetizing dispenser. According to this embodiment, the magnet assembly can be in the form of a semi-cylindrical column multipole magnet 190. The multipole magnet 190 has alternating polarity configurations of S-N-S, i.e. south magnetic poles at opposite ends of the magnet and a north magnetic pole between the two south magnetic poles. The total number of magnetic poles in the magnet 190 can be an odd number, i.e. three, five, and so on.

The semi-cylindrical surface 192 of the semi-cylindrical magnet 190 can be abutted against and affixed to the inner cylindrical surface of the magnetizing dispenser. Flux lines F27, as depicted in FIG. 37a, express the directions of the magnetic fields within the magnetizing dispenser.

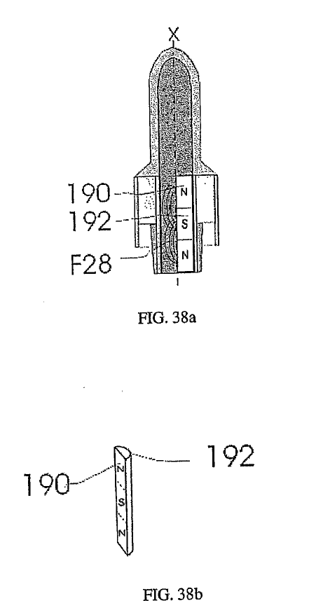

FIGS. 38a and 38b show another embodiment of the magnet assembly of the magnetizing dispenser. According to this embodiment, the magnet assembly can be in the form of a semi-cylindrical column multipole magnet 190. The multipole magnet 190 has alternating polarity configurations of N-S-N, i.e. north magnetic poles at opposite ends of the magnet and a south magnetic pole between the two north magnetic poles. The total number of magnetic poles in the magnet 190 can be an odd number, i.e. three, five, and so on.

Similarly, the semi-cylindrical surface 192 of the semi-cylindrical magnet 190 can be abutted against and affixed to the inner cylindrical surface of the dispenser. The directions of the magnetic fields within the magnetizing dispenser are expressed by flux lines F28, as depicted in FIG. 38a.

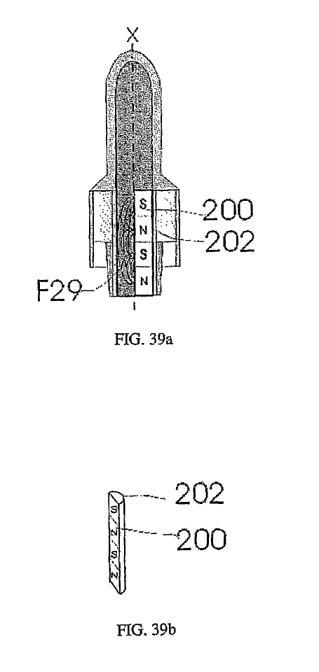

FIGS. 39a and 39b show another embodiment of the magnet assembly of the magnetizing dispenser. According to this embodiment, the magnet assembly may in the form of a semi-cylindrical column multipole magnet 200 having alternating polarity configurations S-N-S-N, as counted from top to bottom. The total number of magnetic poles in the magnet 200 may be an even number, i.e. four, six, and so on.

The semi-cylindrical surface 202 of the semi-cylindrical magnet 200 may be abutted against and affixed to the inner cylindrical surface of the magnetizing dispenser. Flux lines F29, as depicted in FIG. 39a, represent the directions of the magnetic fields within the magnetizing dispenser.

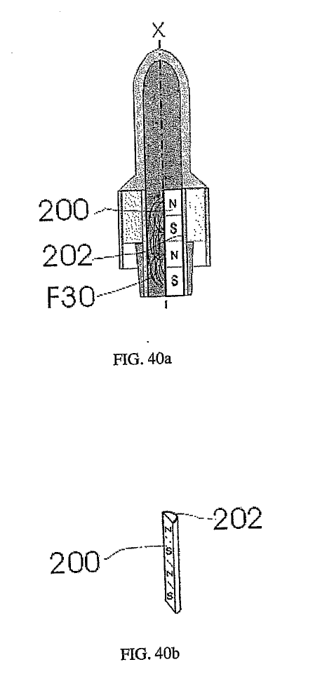

FIGS. 40a and 40b show another embodiment of the magnet assembly of the magnetizing dispenser. According to this embodiment, the magnet assembly is the same semi-cylindrical column multipole magnet 200 as illustrated in FIGS. 39a and 39b, but oriented up side down with alternating polarity configurations N-S-N-S, as counted from top to bottom. Again, the total number of magnetic poles in the magnet 200 may be an even number.

Similarly, the semi-cylindrical surface 202 of the semi-cylindrical magnet 200 may be abutted against and affixed to the inner cylindrical surface of the dispenser. The directions of the magnetic fields within the magnetizing dispenser are represented by flux lines F30, as depicted in FIG. 40a.

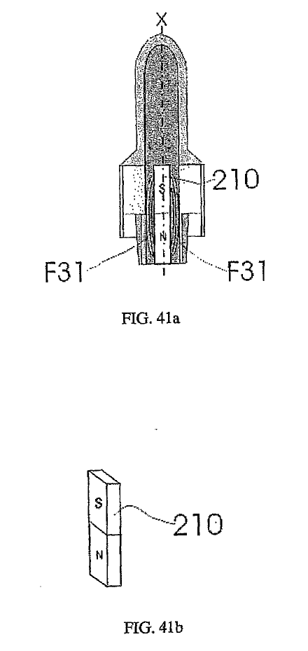

FIGS. 41a and 41b show another embodiment of the magnet assembly of the magnetizing dispenser. According to this embodiment, the magnet assembly may be in the form of a rectangular or bar-type dipole magnet 210 having the south magnetic pole at the upper half thereof and the north magnetic pole at the lower half thereof.

The magnet 210 extends along the flow through opening 108 of the magnetizing dispenser in the middle thereof. Flux lines F31, as depicted in FIG. 41a, denote the directions of the magnetic fields within the magnetizing dispenser.

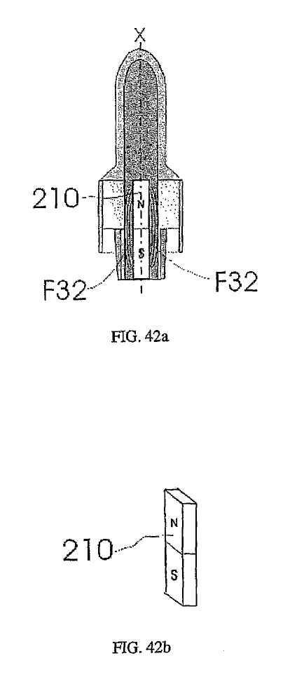

FIGS. 42a and 42b show another embodiment of the magnet assembly of the magnetizing dispenser. According to this embodiment, the magnet assembly is the same rectangular or bar-type dipole magnet 210 as shown in FIGS. 41a and 41b but oriented up side down with the north magnetic pole at the upper half thereof and the south magnetic pole at the lower half thereof.

Again, the magnet 210 extends along the flow through opening 108 of the magnetizing dispenser in the middle thereof. The directions of the magnetic fields within the magnetizing dispenser are conventionally expressed by flux lines F32.

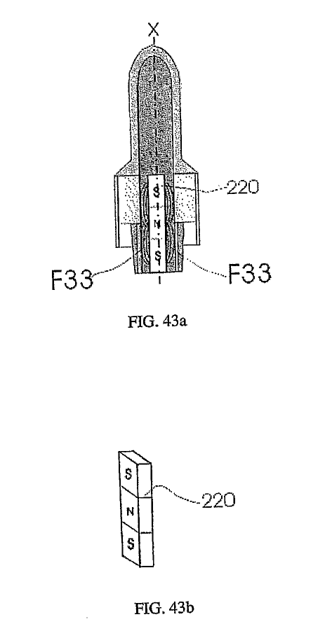

FIGS. 43a and 43b show another embodiment of the magnet assembly of the magnetizing dispenser. According to this embodiment, the magnet assembly may be in the form of a rectangular or bar-type multipole magnet 220 having south magnetic poles at opposite ends thereof and a north magnetic pole between the two south magnetic poles. The magnetic poles arrangement is S-N-S. The total number of magnetic poles in the magnet 220 may be an odd number, i.e. three, five, and so on.

The magnet 220 extends along the flow through opening 108 of the magnetizing dispenser in the middle thereof. Flux lines F33, as depicted in FIG. 43a, represent the directions of the magnetic fields within the magnetizing dispenser.

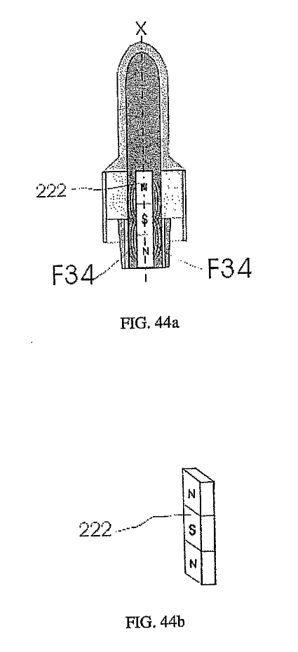

FIGS. 44a and 44b show another embodiment of the magnet assembly of the magnetizing dispenser. According to this embodiment, the magnet assembly may be in the form of a rectangular or bar-type multipole magnet 222 having north magnetic poles at opposite ends thereof and a south magnetic pole between the two north magnetic poles. The magnetic poles arrangement is N-S-N. The total number of magnetic poles in the magnet 222 may be an odd number.

The magnet 222 extends along the flow through opening 108 of the magnetizing dispenser in the middle thereof. The directions of the magnetic fields within the magnetizing dispenser are expressed by flux lines F34.

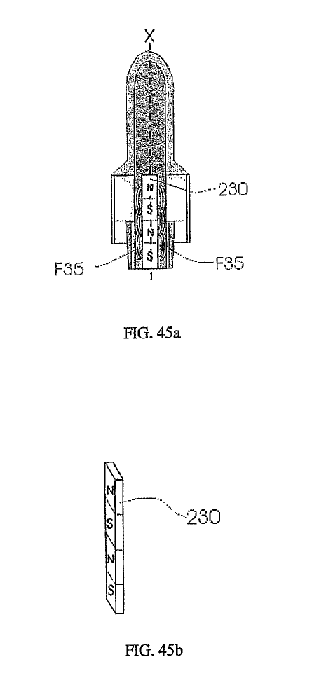

FIGS. 45a and 45b show another embodiment of the magnet assembly of the magnetizing dispenser. According to this embodiment, the magnet assembly can be in the form of a rectangular or bar-type multipole magnet 230 having magnetic poles arrangement N-S-N-S, as counted from top to bottom. The total number of magnetic poles in the magnet 230 can be an even number, e.g. four, six, etc.

The magnet 230 extends along the flow through opening 108 of the magnetizing dispenser as illustrated in FIG. 45a. Flux lines F35 express the directions of the magnetic fields within the magnetizing dispenser.

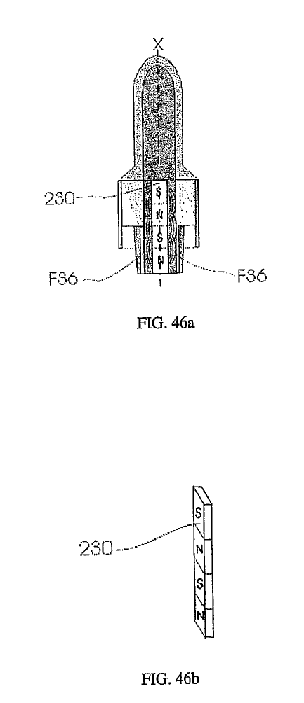

FIGS. 46a and 46b show another embodiment of the magnet assembly of the magnetizing dispenser. According to this embodiment, the magnet assembly can be the same rectangular or bar-type multipole magnet 230 as shown in FIGS. 45a and 45b but turned up side down with magnetic poles arrangement S-N-S-N, as counted from top to bottom. Again, the total number of magnetic poles in the magnet 230 can be an even number.

The magnet 230 is disposed within the flow through opening 108 of the magnetizing dispenser as illustrated in FIG. 46a. The directions of the magnetic fields within the magnetizing dispenser are conventionally expressed by flux lines F36.

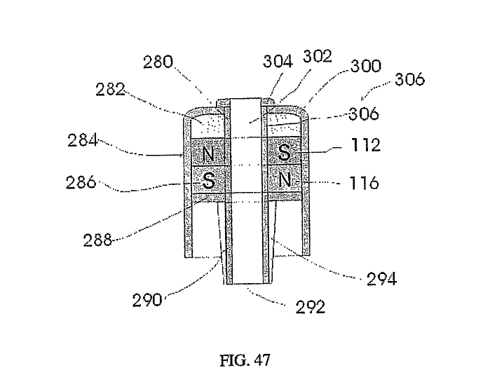

FIGS. 47, 48 and 49 are three different embodiments of the magnetizing dispenser.

According to the embodiment in FIG. 47, the magnetizing dispenser 306 includes a tubular member 306 defining therein a flow through opening 302. The tubular member 306 has an upper portion 280 and a lower portion 290. The lower portion 290 of the tubular member 306 defines a bottle insert 292 which is adapted to be inserted into the mouth 249 of the bottle 250. A generally cylindrical seal 294 is affixed on the outer circumference of the bottle insert 292 for frictional engagement with the mouth 249 of the bottle 250 when the bottle insert 292 is inserted therein. The outer circumference of the seal 294 may be slightly tapered towards the bottom end of the bottle insert 292 to facilitate the insertion of the bottle insert 292 into the mouth 249 of the bottle 250. Preferably, the seal 294 may be made of rubber or any other suitable materials.

A cap-shaped member, generally designated by reference numeral 284, is provided on the tubular member 306 at the upper portion 280 thereof According to the present embodiment, the cap-shaped member 284 may be located adjacent to and above the bottle insert 292. The cap-shaped member 284 may include a shoulder 300, a skirt 286, and a support 288. The shoulder 300, the skirt 286, and the support 288 define a space 282 for receiving therein the dipole ring magnets 112, 116. The support 288 is adapted to support the ring magnets 112, 116.

Although it has been shown that the magnetizing dispenser 246 is provided with dipole ring magnets 112, 116, it is understood that the magnetizing dispenser 246 can be provided with any other magnet assembly described hereinbefore.

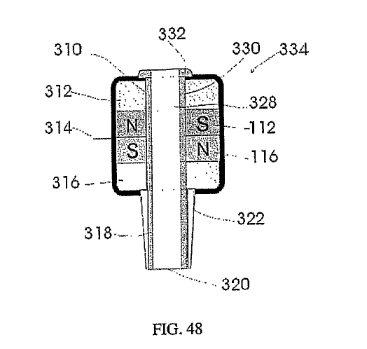

According to the embodiment in FIG. 48, the magnetizing dispenser 334 includes a tubular member 330 defining therein a flow through opening 328. The tubular member 330 has an upper portion 310 and a lower portion 318. The lower portion 318 of the tubular member 330 defines a bottle insert 320 which is adapted to be inserted into the mouth 249 of the bottle 250. A generally cylindrical seal 322 may be affixed on the outer circumference of the bottle insert 320 for frictional engagement with the mouth 249 of the bottle 250 when the bottle insert 320 is inserted therein. The outer circumference of the seal 322 may be slightly tapered towards the bottom end of the bottle insert 320 to facilitate the insertion of the bottle insert 320 into the mouth 249 of the bottle 250. Preferably, the seal 322 is made of rubber or any other suitable materials.

An enclosed compartment, generally designated by reference numeral 314, maybe provided on the tubular member 330 at the upper portion 310 thereof According to the present embodiment, the enclosed compartment 314 may be located adjacent to and above the bottle insert 320. The enclosed compartment 314 may define a space 312 for receiving therein the ring magnets 112, 116. The ring magnets 112, 116 may be disposed in the enclosed compartment 314. A flange 332, identical to the flange 304 in FIG. 47, is provided on the magnetizing dispenser 334.

Although it has been shown that the magnetizing dispenser 334 is provided with dipole ring magnets 112, 116, it is understood that the magnetizing dispenser 334 can be provided with any other magnet assembly described hereinbefore.

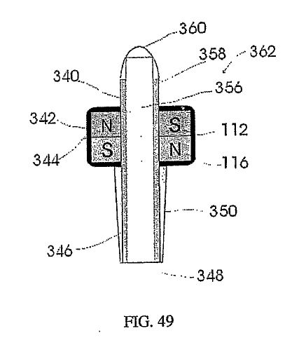

According to the embodiment in FIG. 49, the magnetizing dispenser 362 may include a tubular member 358 defining therein a flow through opening 356. The tubular member 358 has an upper portion 340 and a lower portion 346. The lower portion 346 of the tubular member 358 defines a bottle insert 348 which is adapted to be inserted into the mouth 249 of the bottle 250. A generally cylindrical seal 350 may be affixed on the outer circumference of the bottle insert 348 for frictional engagement with the mouth 249 of the bottle 250 when the bottle insert 348 is inserted therein. The outer circumference of the seal 350 may be slightly tapered towards the bottom end of the bottle insert 348 to facilitate the insertion of the bottle insert 348 into the mouth 249 of the bottle 250. Preferably, the seal 350 is made of rubber or any other suitable materials.

An enclosed compartment, generally designated by reference numeral 344, may be provided on the tubular member 358 at an upper portion 340 thereof. According to the present embodiment, the enclosed compartment 344 may be located adjacent to and above the bottle insert 348. The enclosed compartment 344 may define a space 342 for receiving therein the ring magnets 112, 116.

In the illustrated embodiment, the upper portion 340 of the tubular member 358 protrudes upwards from the compartment 340. A slanted opening end 360 may be provided at the upper end of the tubular member 358.

Although it has been shown that the magnetizing dispenser 362 is provided with dipole ring magnets 112, 116, it is understood that the magnetizing dispenser 362 can be provided with any other magnet assembly described above.

While the present invention has been shown and described with particular references to a number of preferred embodiments thereof, it should be noted that various other changes or modifications may be made without departing from the scope of the present invention.

What is claimed is:

1. A magnetizing fluid dispenser for directly or indirectly attaching to a mouth of a beverage container comprising:
(a) a spout sized and shaped to allow fluid inside the container to be poured out through a predefined path in the spout; and
(b) a magnet capable of generating a magnetic field through which the fluid passes upon being poured out of the container and capable of being adjustably positioned relative to the spout.

2. The dispenser of claim 1 wherein the magnet has a donut shape with a cavity and wherein the fluid passes through the cavity of the magnet when being poured out.

3. The dispenser of claim 1 wherein the magnet and the spout are rotatable with respect to each other.

4. The dispenser of claim 1 wherein the magnetic field cuts through an interface between the fluid being poured out and air at an adjustable angle when pouring the fluid out of the container.

5. The dispenser of claim 1 further comprising a base mount wherein the magnet is fixedly embedded in the base mount and wherein the relative position of the base mount and the spout is adjustable.

6. The dispenser of claim 5 wherein the base mount and the spout are rotatable with respect to each other.

7. The dispenser of claim 5 wherein the base mount has an end adapted to engage with the mouth of the container.

8. The dispenser of claim 5 wherein the base mount includes a dial surface with a plurality of indicia provided thereon and wherein the spout is provided with a pointer pointing at one of said plurality of indicia.

9. The dispenser of 8 wherein the dial surface on the base mount is a clock style.
